(19) United States
(12) Patent Application Publication
(10) Pub. No.: US 2007/0131367 A1
(43) Pub. Date: Jun. 14, 2007

(54) Tissue containing relatively high basis weight buckled regions

(76) Inventors: Jeffrey David Mathews, Neenah, WI (US); David Glen Biggs, Neenah, WI (US); Jeffrey Janne Johnson, Neenah, WI (US); Lacey Leigh Poole, Reno, TX (US); Maurizio Tirimacco, Appleton, WI (US)

Correspondence Address: KIMBERLY-CLARK WORLDWIDE, INC., 401 NORTH LAKE STREET, NEENAH, WI, 54956, US

(21) Appl. No.: 11/301,809

(22) Filed: Dec. 12, 2005

(51) Int. Cl. D21F 11/00; B31F 1/00

(52) U.S. Cl. 162/117; 162/111; 162/205; 428/156

(57) ABSTRACT

Tissue and towel sheets having a pattern of spaced-apart elongated regions of relatively high basis weight oriented in the machine direction of the sheets are produced by forming a molded three-dimensional wet web having spaced-apart ridges and valleys substantially oriented in the machine direction and thereafter flattening the molded web such that the web is buckled upon itself. Upon drying, the resulting tissue sheet has a relatively flat surface texture, yet contains a high degree of cross-machine direction stretch.

### BACKGROUND OF THE INVENTION

Tissue products, which include facial tissue, bath tissue, paper towels, table napkins and the like, typically derive their strength from naturally-occurring hydrogen bonds that form between cellulose fibers upon removal of water. In most cases, this bonding is uniform throughout the structure. Most tissue making processes incorporate the use of multiple fabrics on the tissue machine to facilitate water removal and movement of the tissue web. Typically, flat fabrics with a very small average pore size are used in the forming section. The topography, pore sizes, and composition of subsequent fabrics differ by product and the manufacturer. For example, in producing uncreped throughdried (UCTAD) tissue products as described in U.S. patent application Ser. No. 10/745,184 to Hada et al., a series of fabrics following the forming fabric may be used, such as a topographic transfer fabric and a second topographic throughdrying (TAD) fabric. The particular topography pattern of each fabric is designed to impart the desired physical and aesthetic properties to the final tissue product.

One physical property that is believed to be necessary for the production of high quality tissue is good stretch. Broken into its directional components, stretch is typically defined as machine direction (MD) stretch and cross-machine direction (CD) stretch. Unmodified tissues made with fabrics having no topography inherently have MD stretch values of about 4 percent and CD stretch values of about 2 percent. Tissue with such low stretch values is known to not perform well in-use. Therefore, tissue manufacturers use various means to impart the stretch necessary for in-use durability. MD stretch is typically imparted by creping or rush transfer. These methods are well known in the art. CD stretch development, on the other hand, is a bit more complex. Methods of making UCTAD tissue as described in the above-mentioned Hada et al. patent, for example, utilize topographical transfer fabrics or topographical throughdrying fabrics to make tissue with acceptable CD stretch. By increasing the CD path length (molding into MD-aligned ripples), CD stretch is typically increased by more than 100 percent over a comparable un-molded tissue. One disadvantage of this approach is the inseparable tie between the finished product topographical appearance and the finished product CD stretch. For instance, if certain consumers prefer tissue with a flat surface or textural features other than MD ripples, another method to impart CD stretch into the product is necessary.

Therefore there is a need for a method of imparting CD stretch to tissue sheets that does not rely on a highly topographical texture in the final tissue product.

### SUMMARY OF THE INVENTION

It has now been discovered that the topographical texture of a tissue sheet can be independent of the degree of CD stretch in the sheet. More specifically, a method is disclosed that is capable of producing a relatively flat tissue product with stretch values similar to tissue products which have been molded into a more topographical pattern. This is achieved by producing a new tissue sheet structure that contains a pattern of substantially MD-oriented alternating high and low basis weight regions resulting from z-direction buckling of the sheet during manufacture.

Hence, in one aspect the invention resides in a method of making a tissue or towel sheet comprising: (a) forming a wet tissue web by depositing an aqueous suspension of papermaking fibers onto a forming fabric; (b) transferring the wet tissue web to a molding fabric which imparts a three-dimensional contour to the web, said contour having spaced-apart elongated elevated regions aligned in the machine direction; (c) removing the wet molded web from the molding fabric; and (d) flattening the molded web, wherein elongated machine direction-oriented buckled regions are created, said buckled regions having a basis weight that is higher than the average basis weight of the web.

In another aspect, the invention resides in a tissue or towel sheet having a pattern of spaced-apart, elongated, substantially machine direction-oriented buckled regions having a basis weight greater than the average basis weight of the sheet.

As used herein, the terms “tissue sheet” or “tissue web” include any relatively low density paper sheet or web useful for making or for use as facial tissue, bath tissue, paper towels, table napkins and the like.

As used herein, a “buckled region” is an area of the sheet which is or has been folded upon itself. Buckled regions are visible to naked eye and appear on one side of the sheet as creases or severe elongated indentations and appear on the other side of the sheet as elongated bumps or ridges. Structurally similar features are commonly present in creped tissues in the form of crepe folds, except such structures are oriented in the cross-machine direction of the sheet. The nature of the buckled regions can be quantified by the “buckled tissue index” as hereinafter described. The tissue sheets of this invention can have a buckled tissue index of about −0.05 or less, more specifically from about −0.05 to about −0.40, more specifically from about −0.10 to about −0.35.

As used herein, “substantially machine direction-oriented” means the orientation is less than 45 degrees from the machine direction of the sheet, more specifically less than 25 degrees, more specifically less than 15 degrees, and still more specifically less than 5 degrees from the machine direction of the sheet.

As used herein, a “three-dimensional contour” of sheets or fabrics refers to their z-direction surface height variation, more specifically the distance between the low and high points on the sheet or the web-facing side of the fabric. Height variations may be measured by any standard surface topography quantification method known in the art. Three-dimensional fabrics that are able to impart buckles can have z-direction surface height variations from about 0.5 millimeters to about 5 millimeters or greater, more specifically from about 1 millimeter about 4 millimeters.

The moisture content of the “wet” molded web prior to being flattened can be from about 15 to about 80 percent, more specifically from about 20 to about 70 percent, and still more specifically from about 25 to about 50 percent. If the web is too wet, buckles are not formed due to fiber rearrangement. If the web is too dry, buckles are not formed because of the lack of hydrogen bonds formed in the buckled region. However, the latter case may be mitigated by the surface application of adhesive or bonding agents to hold the buckles in place. In this case, a substantially dry web may be buckled. An example of buckling a dry web is provided herein for towel product.

“Flattening” of the three-dimensionally-contoured molded web can be achieved by transferring the wet web to a fabric or other surface having a relatively flat contour. Such relatively flat fabrics have a z-directional topographical surface height variation of about 0.3 millimeters or less.

The average basis weight of the tissue sheets in accordance with this invention can be from about 15 to about 80 grams per square meter (gsm), more specifically from about 20 to about 60 gsm and still more specifically from about 20 to about 40 gsm. The average basis weight will depend upon the particular product form, such as facial tissue, bath tissue, paper towel, etc. and the number of tissue sheets (plies) in the product.

The ratio of the basis weight of the machine direction-oriented buckled regions relative to the average basis weight of the sheet can be about 1.5 or greater, more specifically from about 1.5 to about 3, and still more specifically from about 2 to about 2.5.

The CD stretch of the tissue sheets of this invention can be about 5 percent or greater, more specifically from about 5 to about 25 percent, more specifically from about 5 to about 20 percent, more specifically from about 10 to about 20 percent. Factors influencing the level of CD stretch include the level and type of buckling, fiber length, and tissue manufacturing and processing variables.

The CD TEA of the tissue sheets of this invention, which is indicative of the overall durability of a tissue sheet, can be about 3 grams-centimeter per square centimeter (g-cm/cm²) or greater, more specifically from about 3 to about 30 g-cm/cm², more specifically from about 4 to about 25 g-cm/cm², and still more specifically from about 5 to about 25 g-cm/cm². Factors affecting CD TEA are similar to those that influence CD stretch.

The CD Slope of the tissue sheets of this invention, which is indicative of the softness or stiffness of the sheet, will depend on the particular product and the process conditions. More specifically, the CD Slope can be from about 3 to about 15 grams per 3 inches of sample width, more specifically from about 3 to about 10 grams per 3 inches of sample width, and still more specifically from about 3 to about 8 grams per 3 inches of sample width.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

### BRIEF DESCRIPTION OF THE DRAWINGS

FIG. 1A is a schematic illustration of the method of this invention, showing how a wet tissue web having a three-dimensional contour is transformed into a buckled web having a cross-machine direction alternating pattern of high and low basis weight regions.

FIG. 1B is schematic plan view of the buckled web of FIG. 1A, illustrating the machine direction-oriented regions of high and low basis weight.

FIG. 2A is a schematic diagram of a tissue machine suitable for making buckled webs in accordance with this invention, particularly webs suitable for use as facial or bath tissue and paper towels.

FIG. 2B is a schematic diagram of a post treatment useful for making paper towels of this invention from tissue sheets having a three-dimensional contour.

FIG. 3 is a another schematic diagram of a tissue machine suitable for making buckled webs in accordance with this invention, particularly webs suitable for use as facial tissue.

FIG. 4 is a schematic illustration of the optical imaging set-up for measuring basis weight profiles as described below.

FIG. 5 is a schematic illustration of the tissue straining frame used to strain the samples for the optical basis weight profiling method as described below.

FIG. 6 is a plan view photograph, illuminated by transmitted light, of a segment (measuring 49×37 millimeters) of an unstrained bath tissue of this invention made as described in Example 10 herein, illustrating the machine direction-oriented buckled regions of higher basis weight, which are shown as the spaced-apart vertical dark lines.

FIG. 7 is a plan view photograph of the tissue of FIG. 6 (also measuring 49×37 millimeters), but strained 7 percent.

FIGS. 8 and 9 show the basis weight profile of the tissue presented in FIGS. 6 and 7 at 0 percent and 7 percent strain, respectively. These profiles quantitatively indicate the basis weight differences between the buckled regions and the balance of the tissue sheet.

FIG. 10 is a bar graph of the buckled tissue index, as measured by the basis weight profiling method described herein, for several tissues in accordance with this invention and two commercially-available tissue products.

### DETAILED DESCRIPTION OF THE DRAWINGS

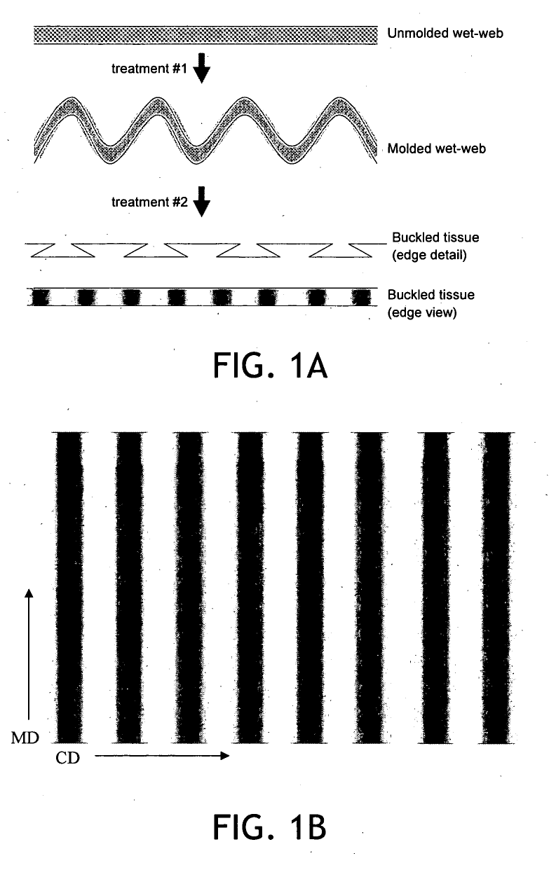

Referring to FIGS. 1A and 1B, the concept of the invention is schematically described. As shown, starting from a flat wet tissue web or sheet as typically produced on conventional forming fabrics and viewed in the machine direction, the wet tissue web is molded into a three-dimensional contour (treatment #1), which strains the wet web in the cross-machine direction. For purposes of this simplistic illustration, the three-dimensional contour is shown as a sinusoidal pattern running in the cross-machine direction of the sheet. Consequently, there are spaced-apart ridges and valleys running (oriented) in the machine direction of the sheet. It will be appreciated that, in reality, the configuration of an actual tissue sheet will most likely be less uniform or regular, in part due to the complex surface contours imparted by the use of woven papermaking fabrics. As shown, treatment #2 (flattening the web) removes or substantially removes the three-dimensional molded pattern by buckling the contours such that they fold over each other and returning the tissue web to an overall relatively flat state. As a consequence, repeating MD-oriented elongated “buckled regions” of relatively high basis weights, separated by MD-oriented regions of relatively low basis weights, are created.

As shown in FIGS. 1A and 1B, the relatively low basis weight areas, which are shown as un-shaded, correspond to the sinusoidal peaks and valleys of the molded web. The relatively high basis weight areas, which are shown as the darker shaded areas, correspond to the transition areas between the peaks and valleys and are generally oriented in the machine direction of the web. In creating these buckled regions, the molded web is not merely be ironed out, as would be the case with dry calendering. Instead, in order for the areas of differing basis weight to be formed, the points corresponding to the peaks and valleys of the undulations of the molded web must remain substantially fixed in the x-y direction so the z-direction compression is effective in creating the desired heterogeneous basis weight profile. This is accomplished due to the constraining nature of the frictional forces between the tissue web and the relatively flat buckling surface to which the three-dimensional web is transferred. Whether that surface is a polymer-based flat fabric, or a metal dryer, the buckles are a result of z-directional flattening accomplished at the expense of in-plane web expansion.

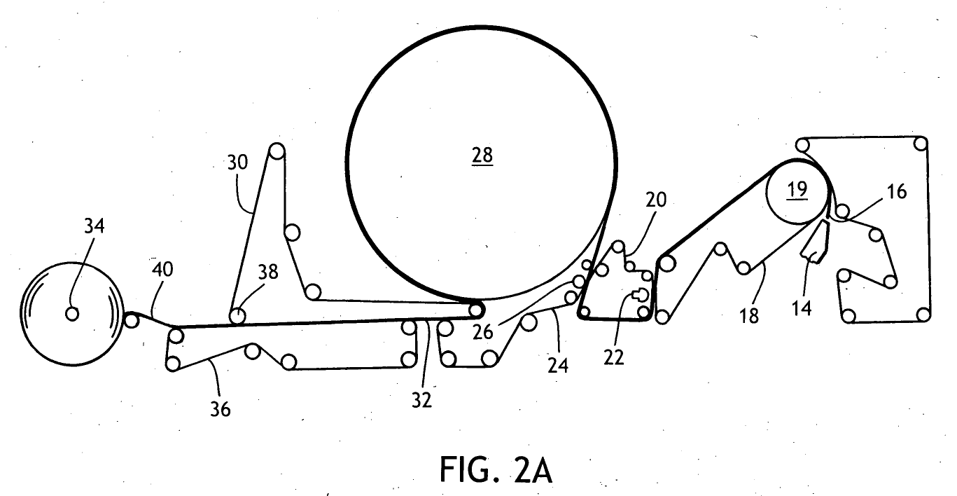

Referring to FIG. 2A, shown is a method for making throughdried paper sheets in accordance with this invention. (For simplicity, various tensioning rolls schematically used to define the several fabric runs are shown but not numbered. It will be appreciated that many variations from the apparatus and method illustrated in FIG. 2A can be made without departing from the scope of the invention). Shown is a twin wire former having a papermaking headbox 14, such as a layered headbox, which injects or deposits a stream 16 of an aqueous suspension of papermaking fibers onto the forming fabric 18 positioned on a forming roll 19. The forming fabric serves to support and carry the newly-formed wet web downstream in the process as the web is typically partially dewatered to a consistency of about 10 dry weight percent. Additional dewatering of the wet web can be carried out, such as by vacuum suction, while the wet web is supported by the forming fabric.

The wet web, which is relatively flat, is then transferred from the forming fabric to a transfer fabric 20 to effect treatment #1. Advantageously, the transfer fabric can be traveling at a slower speed than the forming fabric in order to impart increased stretch into the web. This is commonly referred to as a “rush” transfer. The relative speed difference between the two fabrics can be from 0 to about 60 percent, more specifically from about 15 to about 45 percent. Transfer is preferably carried out with the assistance of a vacuum shoe 22, suitably such that the forming fabric and the transfer fabric simultaneously converge and diverge at the leading edge of the vacuum slot. Suitably, in order to provide the three-dimensional molding of the web while in a relatively wet state, the transfer fabric can contain high and long impression knuckles or spaced-apart ridges and valleys running in the machine direction of the web. For example, the transfer fabric can have about from about 5 to about 300 impression knuckles per square inch which are raised at least about 0.005 inches above the plane of the fabric. The height profile of such fabrics, when viewed from a cross-machine direction perspective, is sinusoidal in nature. Suitable three-dimensional transfer fabrics are well known in the art, such as those known typically used as highly-contoured throughdrying fabrics, such as those described in U.S. Pat. No. 5,429,686 issued to Chiu et al. and U.S. Pat. No. 5,672,248 issued to Wendt, et al., both of which are herein incorporated by reference. Additional topographical fabrics with MD dominant features which can be utilized are described in U.S. Patent Application No. 2003/0084953 A1 published on May 8, 2003 to Burazin et al., herein incorporated by reference.

The web is then transferred from the transfer fabric to a relatively flat throughdrying fabric 24 (treatment #2) with the aid of a vacuum transfer roll 26 or a vacuum transfer shoe. This transfer causes the three-dimensional machine directions ridges to buckle and create the machine direction-oriented regions of higher basis weight as described above. The throughdrying fabric can be traveling at about the same speed or a different speed relative to the transfer fabric. If desired, the throughdrying fabric can be run at a slower speed to further increase machine direction stretch. Transfer can be carried out with vacuum assistance to ensure deformation of the sheet to conform to the throughdrying fabric without in-plane expansion. The level of vacuum used for the web transfers can be from about 3 to about 15 inches of mercury (75 to about 380 millimeters of mercury), preferably about 5 inches (125 millimeters) of mercury. The vacuum shoe (negative pressure) can be supplemented or replaced by the use of positive pressure from the opposite side of the web to blow the web onto the next fabric in addition to or as a replacement for sucking it onto the next fabric with vacuum. Also, a vacuum roll or rolls can be used to replace the vacuum shoe(s).

While supported by the throughdrying fabric, the web is final dried to a consistency of about 94 percent or greater by the throughdryer 28 to set the new structure with hydrogen bonding.

After drying the dried web 32 is transferred to a carrier fabric 30 and transported to the reel 34 using carrier fabric 30 and an optional carrier fabric 36. An optional pressurized turning roll 38 can be used to facilitate transfer of the web from carrier fabric 30 to fabric 36. In either case, the web 40 is wound into a roll for subsequent converting operations to produce the final product form. Suitable carrier fabrics for this purpose are Albany International 84M or 94M, Asten 959, 934, or 937, and Voith Fabrics 2164 and 44GST, all of which are relatively smooth fabrics having a fine pattern. Although not shown, reel calendering or subsequent off-line calendering can be used to improve the smoothness and softness of the basesheet.

Referring to FIG. 2B, a post treatment for making paper towels is disclosed in which a bonding material is applied to each side of the dried sheet and at least one side of the sheet is thereafter creped: In this embodiment, the dried sheet comes in to the post treatment process having a three-dimensional topography that is set by hydrogen bonds. To buckle the dry sheet and create the machine direction basis weight regions of this invention, the surface of the sheet is temporarily rewetted and provided with a bonding material that, after flattening the sheet, sets the buckled structure with covalent bonds. In general, for most applications, the paper sheet will only be creped on one side after the bonding materials are applied. It should be understood, however, that in some situations it may be desirable to crepe both sides of the sheet.

As shown, dried paper sheet 41 can be made according to a process as generally illustrated in FIG. 2A, but using a three-dimensional throughdrying fabric to provide the dried sheet 41 with a three-dimensional topography for subsequent buckling. This topographic dry sheet is then passed through a first bonding agent application station 42. Station 42 includes a nip formed by a smooth rubber press roll 44 and a patterned rotogravure roll 46. Rotogravure roll 46 is in communication with a reservoir 48 containing a first bonding material 50. Rotogravure roll 46 applies the bonding material 50 to one side of sheet 41 in a pre-selected pattern.

Sheet 41 is then contacted with a heated roll 52 after passing a roll 54. The heated roll 52 serves to partially dry the sheet. In general, the sheet can be heated to any temperature sufficient to dry the sheet and evaporate water. Besides the heated roll 52, any suitable heating device can be used to dry the sheet, such as an infra-red heater or any suitable convective oven or microwave oven, for example.

From the heated roll 52, the sheet 41 can be advanced by pull rolls 56 to an optional second bonding material application station. Station 58 includes a transfer roll 60 in contact with a rotogravure roll 62, which is in communication with a reservoir 64 containing a second bonding material 66. Similar to station 42, second bonding material 66 is applied to the opposite side of sheet 41 in a pre-selected pattern. Once the second bonding material is applied, sheet 41 is adhered to a creping roll 78 by a relatively flat press roll 70. At this point, any topography of the sheet 41 is flattened and turned into buckles. Sheet 41 is carried on the surface of the creping drum 78 for a distance and dried to lock in the structure of the buckled regions. The dried sheet is then dislodged from the creping drum by the action of a creping blade 72. The creping blade 72 performs a controlled pattern creping operation on the second side of the paper web.

Once creped, creped paper sheet 73 is pulled through a drying station 74. Drying station 74 can include any form of a heating unit, such as an oven energized by infrared heat, microwave energy, hot air or the like. Drying station 74 may be necessary in some applications to completely dry the sheet and/or further cure the first and second bonding materials. Depending upon the bonding agents selected, however, in other applications drying station 74 may not be needed.

The bonding materials applied to each side of the paper sheet are selected not only for assisting in creping the sheet but also for adding dry strength, wet strength, stretchability and tear resistance to the paper. Particular bonding materials that may be used include latex compositions, such as acrylates, vinyl acetates, vinyl chlorides and methacrylates. Some water-soluble bonding materials may also be used including polyacrylamides, polyvinyl alcohols and cellulose derivatives such as carboxymethyl cellulose. In one embodiment, the bonding materials comprise an ethylene vinyl acetate copolymer. In particular, the ethylene vinyl acetate copolymer can be cross-linked with N-methyl acrylamide groups using an acid catalyst. Suitable acid catalysts include ammonium chloride, citric acid and maleic acid.

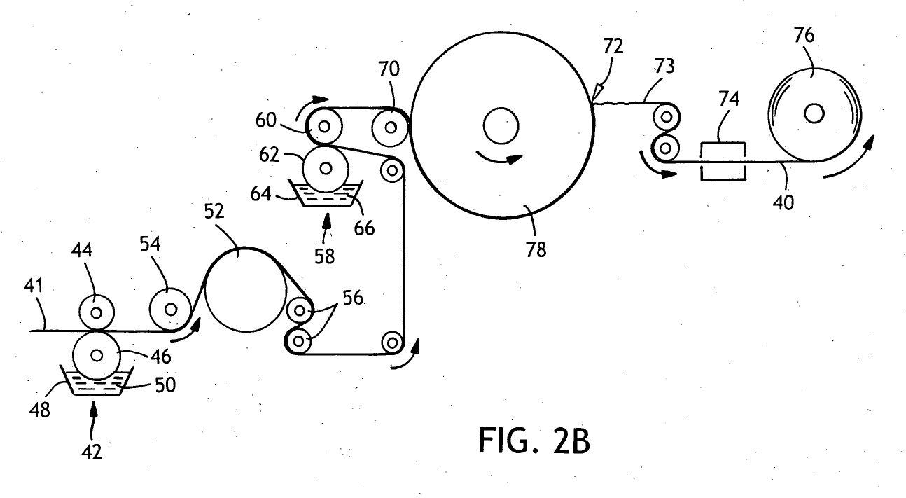

FIG. 3 illustrates another tissue machine configuration suitable for making buckled webs in accordance with this invention. In this configuration, the tissue web is partially dried in a throughdryer on a throughdrying fabric and then passed to an impression fabric for pressing the partially-dried web onto the surface of a Yankee dryer for final drying. The process is similar to that of FIG. 2A, but in this case the throughdrying fabric is the molding fabric and the impression fabric (and nip between the impression roll and Yankee dryer flat surfaces) serves to flatten and buckle the web. With this method, the web must be wet enough during the flattening step to form hydrogen bonds in the buckles. For this purpose, the moisture content of the web during flattening must be at least greater than 15 percent.

More specifically, shown is the papermaking headbox 100 that injects or deposits an aqueous suspension of papermaking fibers between first and second forming fabrics 105 and 106 of a twin wire former to form a wet web 110. Desirably, while the web 110 is sandwiched between the forming fabrics 105 and 106, the web is transported through an air press 115 comprising an air plenum and a collection device, such as a vacuum box, in order to non-compressively dewater the web. The web 110 may also be carried over one or more vacuum or suction boxes (not shown) prior to the air press.

The wet web 110 is thereafter transported by the second forming fabric 106 to a transfer fabric 120. A vacuum pickup roll 125 is used to transfer the wet web 110 from the transfer fabric 120 onto a three-dimensional throughdrying fabric 130. The throughdrying fabric is arranged to carry the web over two throughdryers 135 and 140. As illustrated, a separate transfer fabric 145 sandwiches the web against the throughdrying fabric 130 for transport between the two throughdryers. The web 110 is desirably dried to greater than 35 percent dryness on the second throughdryer 140.

After the second throughdryer 140, a vacuum roll 150 is used to remove the web from the throughdrying fabric 130, whereupon the web is sandwiched between a relatively flat impression fabric 165 and a transfer fabric 170. The web is then pressed onto the surface of a drying cylinder, such as a Yankee dryer 175, with a pressure roll 176. The dried web 180 is desirably removed from the drying cylinder using a creping blade 177 to impart stretch and is then wound into a roll. Of course, the number and arrangement of throughdryers and fabrics may be varied from that shown.

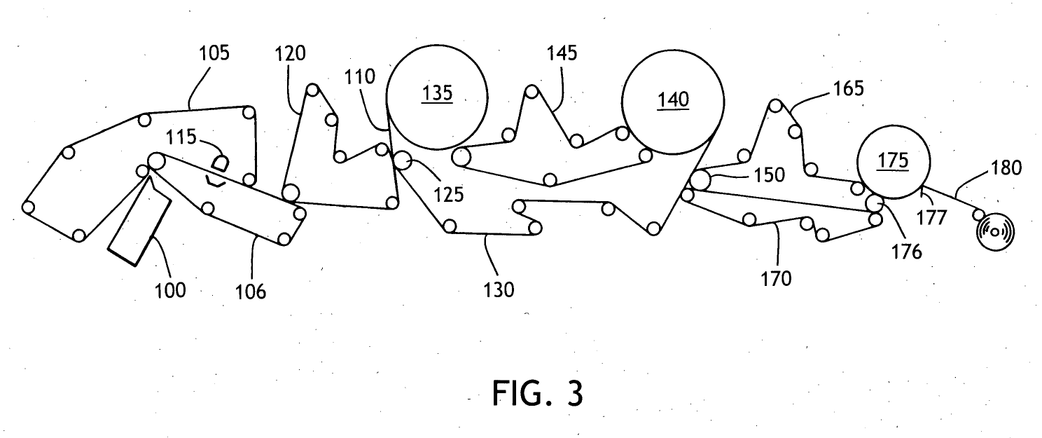

FIG. 4 is a schematic illustration of the optical imaging apparatus set-up for measuring basis weight profile and is described in more detail in connection with the description of the basis weight profile test method as described below. Shown is a Sony video camera 200 suitably mounted on a Polaroid MP4 standard support 201, a 1:1 relay adaptor 202, a 35-mm Nikon lens 203, the sample stretching frame 205 (which includes the tissue sample being measured), an auto-stage 207, a sheet of ¼ inch Plexi-glass 208, a 14 inches by 11 inches mask 209, a Kreonite Macro-viewer 210, including a Chroma Pro 45 211.

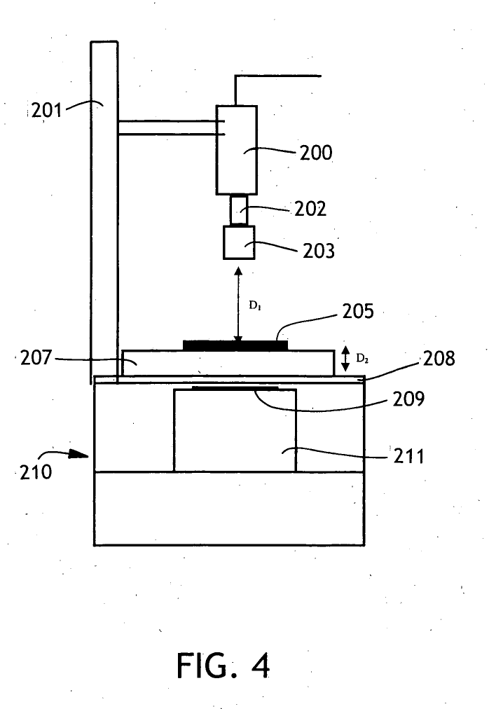

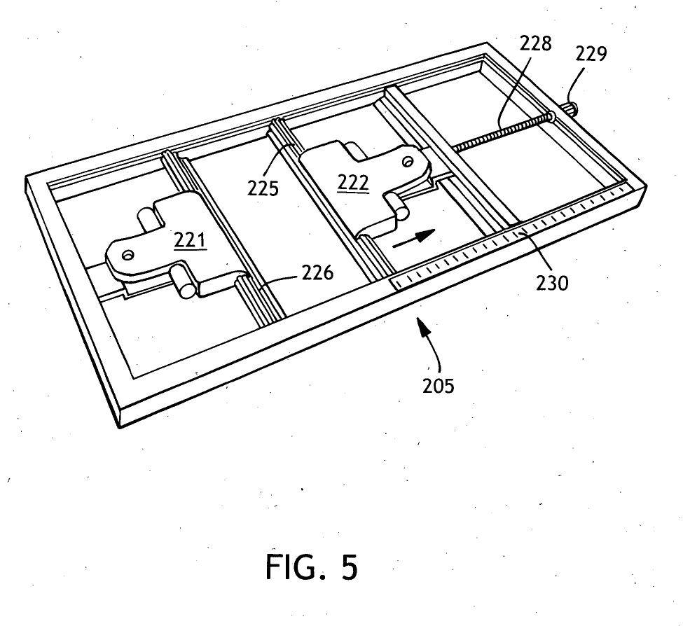

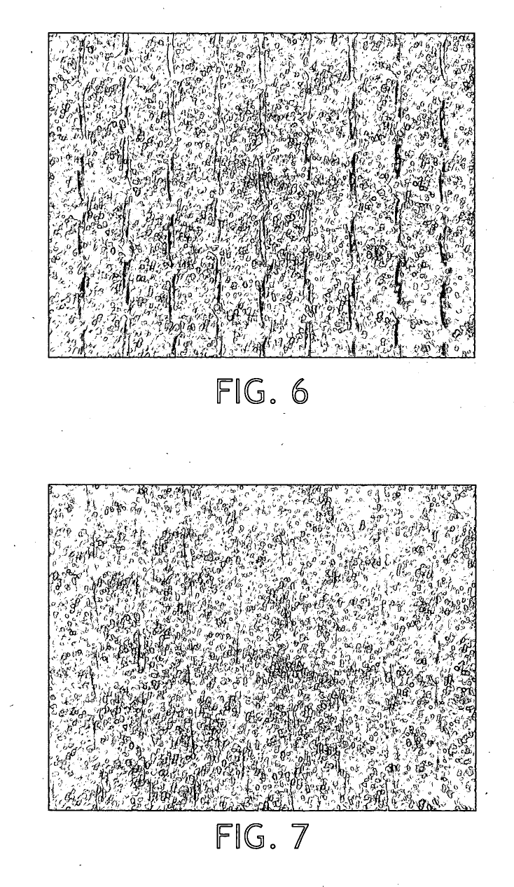

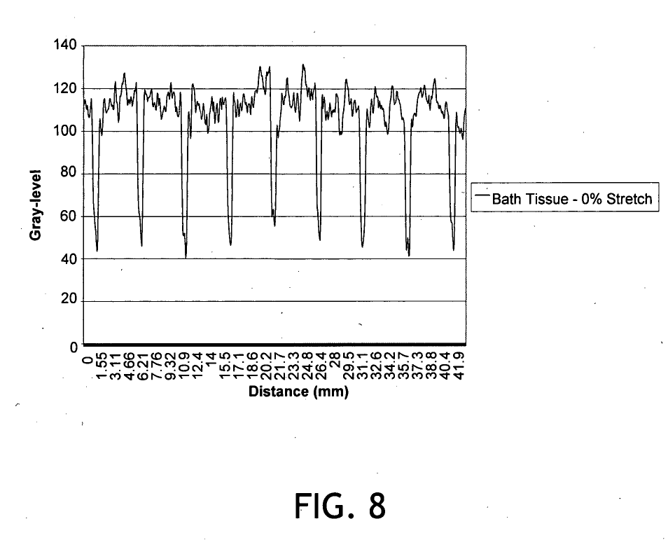

FIG. 5 is a drawing of the tissue straining frame 205 used to strain the samples during basis weight profiling as described below. Shown are sample clamps 221 and 222 having extended rubber-lined jaws 225 and 226 which securely hold the two side edges of the tissue sample, which spans the distance between the sample clamps. The tissue sample is placed in the sample clamps with the machine direction of the tissue sample parallel to the edges of the jaws. Clamp 222 is attached to a screw 228 having a knob 229 that can be turned to move the clamp away from the sample to stretch the sample. The degree of strain imparted to the tissue sample can be measured using the scale 229 on the side of the frame.

### Test Methods

Basis Weight Profile

Quantification of the increased basis weight in the buckled regions of the sheet is measured using image analysis techniques as described below. More specifically, a series of basis weight line profiles are taken on tissue at 0 percent, 2 percent, 5 percent, and 7 percent CD strain. The percentage of pixels with intensity values less than 2 times the standard deviation of the profile was plotted at each level of stretch. Finally, the slope of the linear trend line obtained from the number of values less than two times the standard deviation at each stretch level, plotted against tissue strain, is the buckled index. For purposes herein, tissue webs having a buckled index less than zero (0) have buckled regions in accordance with this invention. On the other hand, tissue webs having a buckled index of zero (0) or greater do not have buckled regions.

More specifically, the apparatus and set-up for determining the gray-level profile of tissue sheets will now be described. The test method involves retaining the products, from which samples will be cut, at room temperature of between 68° F. to 72° F. for a time period of 24 hours. After the products have been acclimated, a sample is cut of each product using scissors. The sample is normally cut into a rectangular shape to approximately 120 mm by 120 mm in size. The minimum size sample that can be cut will be approximately 60 mm by 60 mm in size and have a field of view size defined by the dimensions of approximately 48 mm by approximately 37 mm. The sample should be oriented so that the buckled regions are aligned vertically in the image.

The sample may have different textured surfaces due to processing of the material. Ideally, the sample surface facing the camera should also be the surface that best exhibits any buckling effects.

The sample is then clamped into a tissue stretching apparatus (see FIG. 5). This is accomplished by clamping the tissue on one end so that any perceived buckled regions are running parallel to the edge of the clamp. The apparatus is then positioned so that the tissue is suspended vertically. The unclamped tissue end is then allowed to drape in between the second clamp which is held open. When the unclamped end of the tissue is positioned so that it is freely hanging in the vertical position, the second clamp is allowed to slowly close onto the free tissue end. The tissue is now considered to be under 0% stretch conditions. The stretching apparatus is now placed onto the image analysis auto-stage for imaging with the more apparent buckled surface facing the camera.

Referring to FIG. 4, the sample is illuminated in a darkened room with a transmitted light source produced by a Chroma Pro 45. The Chroma Pro is located underneath the sample so that the light emitted from it is shown upward into and through the sample. A 14 inches by 11 inches black aperturing mask is placed on top of the light emitting surface of the Chroma Pro. The sample stretching apparatus rests on top of a transparent piece of glass positioned on a Designed Components Inc. auto-stage, Model HM-1212. The auto-stage was used here as a simple spacer, although it is a motorized apparatus known to those skilled in the analytical arts which was purchased from Design Components Incorporated, which had an office in Franklin, Miss. The resulting image of the sample is detected by a video camera having a 35-millimeter adjustable lens. The adjustable 35-millimeter lens was purchased from Nikon Instruments, Melville, N.Y. The detected image is then processed by an image analysis system to yield a gray-level profile for each tissue sample.

The video camera used was a SONY® video camera (Model DXC-930P) with synchronization and timing option (commonly called PAL format) and the red color channel was used. The adjustable 35-millimeter Nikon lens was mounted on the video camera via 1:1 relay adaptor #C20047 (Century Optics, USA). The 35-millimeter Nikon lens had an f-stop setting of 2.8. The video camera was mounted on a Polaroid MP-4 Land Camera (Polaroid Resource Center, Cambridge, Miss.) standard support. The support was attached to a KREONITE macro-viewer purchased from Kreonite, Inc., (Wichita, Kans.). The auto-stage was placed on the upper surface of the KREONITE macro-viewer, although it could be placed on an equivalent or similar apparatus. The auto stage was used as a spacer between the Chroma Pro 45 and the sample/stretching apparatus.

The distance D₁ represents the distance between the upper surface of the sample and the bottom of the lens. The distance D₁ was set to be approximately 21 centimeters (cm). The distance D₂ represents the vertical distance between the macro-viewer and the auto-stage top surface. The distance D₂ was approximately 16 cm. The sample was illuminated by the Chroma Pro 45 (Zeiss model no. 01-21628-01) which is distributed by Circle S, Inc. (Tempe, Ark.). It was placed just underneath a ¼″ sheet of transparent plexi-glass which sat on top of the macro-viewer as shown if FIG. 4. The distance between the sample and top of the auto-stage was approximately 1.2 cm. A ⅛″ thick, 3 inches by 2¼ inches piece of translucent plexi-glass was positioned just under the sample and on top of the auto-stage. Two glass stirring rods of 5 mm thick diameter were taped to the bottom edges of the plexi-glass and were allowed to sit on the top surface of the auto-stage. These spacing dimensions allowed the translucent plexi-glass to just come into contact with the lower sample surface. The Chroma Pro was connected to a POWERSTAT Variable Autotransformer, type 3PN117C, which was purchased from Superior Electric, Co. having an office in Bristol, Conn. The autotransformer is used to adjust the Chroma Pro's illumination level.

The image analysis system used to generate the gray-level profiles was a Quantimet 600 Image Analysis System available from Leica Microsystems, having an office in Wetzlar, Germany. The system was controlled and run by QWIN Version 1.06A software. The image analysis program ‘TISBW4’ was used to acquire, process and measure images using Quantimet User Interactive Programming System (QUIPS) language. Alternatively, the TISBW4 program could be used with a Quantimet 500 IW Image Analysis System which runs QWIN Version 2.4 software. The custom image analysis program is shown below.
NAME=TISBW4 (TISue Basis Weight 4)
PURPOSE=Measures Tissue Gray-level profiles
CONDITIONS=Sony 3CCD vid. camera; 35-mm adj. Nikon lens (f/2.8); Transmitted light;
pole position=69.0 cm.
Open File (C:\EXCEL\DATA\BW1.XLS, channel #1)
INITIALIZE VARIABLES
CALVALUE=0.0647
GRAPHNX=1
GRAPHNY=2
GRAPHWID=16
GRAPHHGHT=16
GRAPHORGX=100
GRAPHORGY=230
GRAPHTHIK=1
GRAPHOUT=0
GRAPHORNT=0
MFRAMEX=100
MFRAMEY=230
MFRAMEH=16
MFRAMEW=480
Enter Results Header
File Results Header (channel #1)
IMAGE SET UP
Measure frame (x 36, y 194, Width 668, Height 172)
Image Setup [PAUSE] (Camera 5, Gain 49.99, Offset 49.99, Lamp 23.86)
Image frame (x 0, y 0, Width 736, Height 574)

Calibrate (CALVALUE CALUNITS$ per pixel)

ROUTINE TO STABILIZE LIGHT LEVEL
Y = 0
Z = 0
SP = 0
SIB = 0
P = 0
MGREYIMAGE = 0
FIELDS = 1000
TWICE = 0
Measure frame (x 36, y 194, Width 668, Height 172)
Correlation GL Value for top 1% px Method, and SONY DXC930 = 187
For (LIGHT = 1 to 100, step 1)

Image Setup (Camera 5, Gain 49.99, Offset 49.99, Lamp 23.86)
Live On
Measure Grey (plane MGREYIMAGE, mask MGREYMASK,

histogram into GREYHIST(256), stats into
GREYSTATS(3) )

Selected parameters: Pixels, MeanGrey, Std Dev

A = GREYSTATS(2)
B = GREYSTATS(3)
D = A+B
For ( X = 129 to 256, step 1 )

Y = Y+(X*GREYHIST(X))
Z = Z+GREYHIST(X)

Next ( X )
R = Y/Z
TP = GREYSTATS(1)
THREEPCTPX = .03 * TP
For ( X = 256 to 1, step −1 )

If ( THREEPCTPX > SP )

P = GREYHIST(X)
SP = SP + P
SIB = SIB + (X * P)
If ( THREEPCTPX < SP )

X = 1

Endif

Endif

Next ( X )
AVEGL = SIB/SP
E = AVEGL
Display ( E, field width: 8, left justified, 1 digit after ‘.’, no
tab follows )
If (E<188)

If (E>186)

TWICE = TWICE+1
If (TWICE=2)

Goto CONTINUE

Endif

Endif

Endif
Y = 0
Z = 0
SP = 0
SIB = 0

Next (LIGHT)
END LIGHT STABILIZER ROUTINE

CONTINUE:
IMAGE ACQUISITION
Measure frame (x MFRAMEX, y MFRAMEY, Width MFRAMEW, Height MFRAMEH)
Image Setup (Camera 5, Gain 50.01, Offset 49.96, Lamp 23.86)
Acquire [PAUSE] (into Image0)
ANALYSIS LOOP
For (FIELD=1 to 30, step 1)

Graphics (Inverted Grid, GRAPHNX×GRAPHNY Lines, Grid Size GRAPHWID×GRAPHHGHT, Origin GRAPHORGX×GRAPHORGY, Thickness GRAPHTHIK, Orientation GRAPHORNT, to GRAPHOUT Cleared)

Measure feature (plane Binary0, 8 ferets, minimum area: 16, grey image: Image0)
Selected parameters: X FCP, Y FCP, UserDef1, UserDef2, XCentroid,
YCentroid, MeanGrey, UserDef3

Feature Expression (UserDef1 (all features), title XLocation=(PXCENTROID(FTR)−108)*CALVALUE)

Feature Expression (UserDef2 (all features), title YLocation=(PYCENTROID(FTR)−230)*CALVALUE)

Feature Expression (UserDef3 (all features), title Basis Wt.=2.71828**((PMEANGREY(FTR)+175.04)/86.217))

File Feature Results (channel #1)

Feature Histogram #1 (Y Param Number, X Param UserDef3, from 0. to 100, linear, 20 bins)

GRAPHORGX=GRAPHORGX+GRAPHWID

Next (FIELD)

MFRAMEX=36
MFRAMEY=194
MFRAMEH=172
MFRAMEW=668
Measure frame (x MFRAMEX, y MFRAMEY, Width MFRAMEW, Height MFRAMEH)
Measure Profile Horizontal on Image0, Average, Grey)
Display Profile Results

Profile Results Window (0, 638, 512, 256)

Profile Window (2, 671, 576, 256)
File Line (channel #1)
File Profile Results (channel #1)
Close File (channel #1)
End

Prior to testing the first sample, shading correction was performed using the QWIN software and a blank field of view that was illuminated using the Chroma Pro and the translucent plexi-glass. The shading correction was performed using the ‘live’ mode. The system was also accurately calibrated using the QWIN software and a standard ruler with metric markings. The calibration was performed in the horizontal dimension of the video camera image.

After calibrating the system, the QUIPS routine TISBW4 was executed via the QWIN software and this initially prompts the analyst to place the sample within the field-of-view of the video camera. After positioning the sample in the stretching apparatus so the primary buckled region direction is parallel to the vertical direction in the image, the analyst will then be prompted to adjust the light level setting (via the POWERSTAT variable auto transformer) to register between Gray-Level readings of 186-188. During this process of light adjustment, the QUIPS routine TISBW4 will automatically display the current gray-level value on the Quantimet 600 video screen.

After the light has been properly adjusted, the QUIPS routine TISBW4 will then automatically acquire process and measure the gray-level profile of the image. The gray-level scale used on the Quantimet 600 system, or equivalent, is 8-bit and ranges from 0 to 255 (0 represents ‘black’ and 255 represents ‘white’). For gray-level measurements, the entire gray scale will be used.

The QUIPS routine TISBW4 will then measure the gray-level profile and export the data directly to an EXCEL®) spreadsheet. The profile generated at each point was based on the average of the corresponding pixel column of 86 pixels that ran vertically both below and above the central horizontal profile pixel line (172 total pixels). Thus, it is important to align the sample such that any buckling phenomenon is oriented vertically in the image.

After collecting the gray-level profile with 0% stretch of the sample, the analyst will then carefully use the stretching apparatus to stretch the tissue an additional 2 percent beyond its original size based on the dimensions within the stretching apparatus clamps. Again, stretching will be performed in. a direction orthogonal to the buckles orientation.

The whole image analysis and data collection process is again repeated for the collection of the strained tissue. After the 2 percent stretch data is collected, the stretching and image analysis steps are again repeated for 5 percent and 7 percent levels of stretch.

Tensile Strength.

Samples for tensile strength testing are prepared by cutting a 3 inches (76.2 mm) wide×5 inches (127 mm) long strip in either the machine direction (MD) or cross-machine direction (CD) orientation using a JDC Precision Sample Cutter (Thwing-Albert Instrument Company, Philadelphia, Pa., Model No. JDC 3-10, Serial No. 37333). The instrument used for measuring tensile strengths is an MTS Systems Sintech 11 S, Serial No. 6233. The data acquisition software is MTS TestWorks® for Windows Ver. 3.10 (MTS Systems Corp., Research Triangle Park, N.C.). The load cell is selected from either a 50 Newton or 100 Newton maximum, depending on the strength of the sample being tested, such that the majority of peak load values fall between 10-90% of the load cell's full scale value. The gauge length between jaws is 4+/−0.04 inches (101.6+/−1 mm). The jaws are operated using pneumatic-action and are rubber coated. The minimum grip face width is 3 inches (76.2 mm), and the approximate height of a jaw is 0.5 inches (12.7 mm). The crosshead speed is 10+/−0.4 inches/min (254+/−1 mm/min), and the break sensitivity is set at 65%. The sample is placed in the jaws of the instrument, centered both vertically and horizontally. The test is then started and ends when the specimen breaks. The peak load is recorded as either the “MD tensile strength” or the “CD tensile strength” of the specimen depending on the sample being tested. At least six (6) representative specimens are tested for each product and the arithmetic average of all individual specimen tests, either in the MD or CD, is the tensile strength for the product.

Stretch.

“Stretch”, in either the MD or CD, is the average percent elongation of the sample at the breaking point when measuring the tensile strength as described above.

CD TEA.

In addition to measuring the tensile strength and stretch, the cross-machine direction tensile energy absorbed (CD TEA) is also reported by the MTS TestWorks® for Windows Ver. 3.10 program for each sample tested for CD tensile strength. The CD TEA is reported in the units of grams-centimeters/centimeters squared (g-cm/cm²) and is defined as the integral of the force produced by a specimen with its elongation up to the defined break point (65% drop in peak load) divided by the face area of the specimen.

CD Slope.

The “CD Slope” is the average slope of the load/elongation curve described above measured over the range of 0-20 grams (force). The slope is 20 grams (force)/centimeter divided by the strain value corresponding to a load of 20 grams (force)/centimeter when the width of the sample is 1 inch (2.54 cm).

### EXAMPLES

### Examples 1-12

(Bath Tissue).

To further illustrate the invention, bath tissue Examples 1-12 were produced using a pilot uncreped throughdried tissue machine was configured similarly to that illustrated in FIG. 2A and was used to produce a one-ply, uncreped throughdried bath tissue basesheet. More specifically, 50 pounds of bleached northern softwood kraft fiber were dispersed in a pulper for 30 minutes at a consistency of 3 percent. Similarly, 150 pounds of bleached eucalyptus were dispersed in a pulper for 30 minutes at a consistency of 3 percent. The thick stock of both fiber sources were sent separately to machine chests and diluted to a consistency of about 1 percent.

The machine chest furnish was diluted to approximately 0.1 percent consistency and delivered to a forming fabric using a three-layered headbox. The layer fiber weight split was 33 percent/34 percent/33 percent, with 100 percent eucalyptus fiber in the two outer layers and 100 percent softwood in the middle layer. The Voith Fabrics 2164 forming fabric speed was approximately 62 feet per minute (fpm). The resulting web was then transferred to a transfer fabric traveling at 50 fpm using a vacuum shoe to assist the transfer. At a second vacuum shoe assisted transfer, the web was delivered onto a throughdrying fabric. The web was dried with a throughdryer operating at a temperature of 375° C.

The resulting bath tissue basesheet was produced with an oven-dry basis weight of approximately 26 grams per square meter (gsm). The resulting product was equilibrated for at least 4 hours in TAPPI standard conditions (73° F., 50% relative humidity) before tensile testing. All testing was performed on basesheet from the pilot machine without further processing.

Examples 1-3 represent control tissues sheets made with different levels of rush transfer using the same, relatively flat, fabric in the transfer fabric and the throughdrying (TAD) fabric position. The fabric used was a 2164. Examples 4-12 are examples in accordance with this invention in which the tissue sheets are made with a topographic transfer fabric and a relatively flat TAD fabric. More specifically, the transfer fabric (labeled Jetson), which served as the molding fabric for Examples 4-6, had a three-dimensional contour having an MD-dominant design of approximately 5 MD raised elements per centimeter and which were approximately 1 millimeter deep. A CD line trace of this fabric would have the approximate structure of a sine wave with amplitude of 1 millimeter and a frequency of 2 millimeters.

The transfer fabric (labeled Quickdraw), which served as the molding fabric for Examples 7-9, had a three-dimensional contour having an MD-dominant design of approximately 2 MD raised elements per centimeter and which were approximately 2 millimeters deep. A CD line trace of this fabric would have the approximate structure of a sine wave with amplitude of 2 millimeters and a frequency of 5 millimeters.

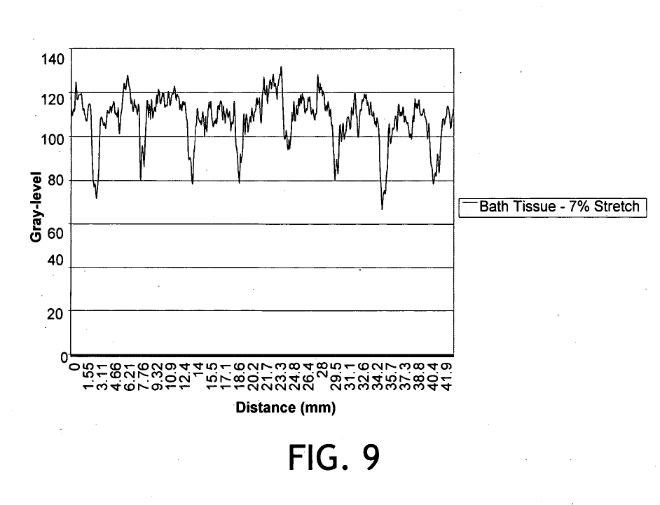

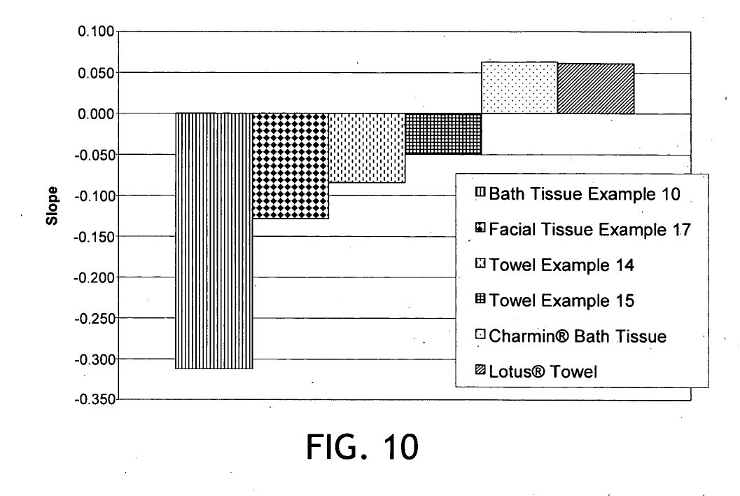

The transfer fabric (labeled IMv1.0), which served as the molding fabric for Examples 10-12, had a three-dimensional contour having an MD-dominant design of approximately 2 MD raised elements per centimeter and which were approximately 3 millimeters deep. A CD line trace of this fabric would have the approximate structure of a sine wave with amplitude of 3 millimeters and a frequency of 5 millimeters. The approximate 5 millimeters frequency of the basis weight spikes depicted for Example 10 in FIG. 9 match the frequency of the IMv1.0 transfer fabric used to produce the buckles in the tissue.

Conversely, the throughdrying fabric, which was a 2164 manufactured by Voith Fabrics, was relatively flat and served to flatten the web. Relative to the schematic method depicted in FIG. 1A, treatment #1 occurred upon transfer of the un-molded web from the forming fabric to the transfer fabric, where the wet web became molded into the surface contour of the highly topographic transfer fabric. Treatment #2, during which the surface contours imparted to the web by the transfer fabric were buckled, occurred upon transfer of the molded wet web to the relatively flat throughdrying fabric. The solids content (consistency) of the wet web prior to treatment #2 was approximately 30 percent.

The results of these Examples are summarized in Table 1. For purposes herein, the 2164 fabric is considered to be a flat fabric which is not sufficiently contoured for use as a molding fabric in accordance with this invention. All of the other fabrics listed as part of this example are sufficiently three-dimensionally contoured to mold the tissue web and impart machine direction oriented buckled regions in accordance with this invention.

TABLE 1
Bath Tissue Data

| | | | | MD | CD | CD | |
|---|---|---|---|---|---|---|---|
| | Transfer | TAD | | Stretch | Stretch | Slope | CD TEA |
| Example | Fabric | Fabric | Rush | % | % | g/3″ | g · cm/cm2 |
| 1 | 2164 | 2164 | 28% | 20.28 | 2.48 | 38.17 | 2.90 |
| (Control) | | | | | | | |
| 2 | 2164 | 2164 | 15% | 8.46 | 2.59 | 44.34 | 2.76 |
| (Control) | | | | | | | |
| 3 | 2164 | 2164 | 8% | 5.01 | 2.35 | 53.83 | 3.05 |
| (Control) | | | | | | | |
| 4 | Jetson | 2164 | 28% | 19.71 | 6.80 | 12.83 | 4.74 |
| 5 | Jetson | 2164 | 15% | 9.20 | 7.53 | 7.67 | 3.63 |
| 6 | Jetson | 2164 | 8% | 5.00 | 6.45 | 10.56 | 3.62 |
| 7 | Quickdraw | 2164 | 28% | 19.29 | 6.33 | 12.64 | 4.14 |
| 8 | Quickdraw | 2164 | 15% | 9.39 | 6.48 | 12.21 | 4.49 |
| 9 | Quickdraw | 2164 | 8% | 5.37 | 5.61 | 18.53 | 4.70 |
| 10 | IM v1.0 | 2164 | 28% | 19.33 | 8.02 | 8.77 | 4.69 |
| 11 | IM v1.0 | 2164 | 15% | 9.29 | 7.77 | 8.64 | 4.51 |
| 12 | IM v1.0 | 2164 | 8% | 5.88 | 6.57 | 9.60 | 3.22 |

As the data show, on average, imparting machine direction oriented buckled regions in accordance with this invention increased CD stretch by nearly 300 percent. Such high increases in CD stretch while using a relatively flat TAD fabric were unexpected because, traditionally, the TAD fabric topography is the primary driver for CD stretch development. It was also unexpected because the abundance of water in the sheet while in its molded state (on the transfer fabric) prevents the formation of hydrogen bonds. Without bonding in the molded state, it was expected that any buckles created from subsequent placement onto a flat TAD fabric would have little or no effect on tissue properties. Therefore, if the molded tissue were to be dried sufficiently to allow for hydrogen bonds to be formed before the molded sheet was flattened, it is expected that the durability of the buckled regions in the final product could be improved, thereby further enhancing the CD stretch and other related properties.

The data also show that, as a result of the increased CD stretch, the CD slope was significantly decreased and the CD TEA was increased when buckles were added to the tissue. Both of these changes are highly desirable.

MD stretch was not affected by the fabric topographies used in this study. It would be expected that if fabrics were designed to impart buckled regions with a cross-machine direction orientation or an orientation having at least a significant cross-machine direction component, MD stretch would be similarly affected by those buckles. However, as previously stated, sufficient MD stretch can easily be developed by other means, such as rush transfer.

### Examples 13-15

(Towels).

Examples 13 (control) and 14-15 (this invention) are paper towel sheets made using a pilot uncreped throughdried tissue machine that was configured similarly to FIG. 2A and post treated in accordance with the process illustrated in FIG. 2B. This machine was used to produce a one-ply, uncreped throughdried towel basesheet. More specifically, 200 pounds of bleached northern softwood kraft fiber were dispersed in a pulper for 30 minutes at a consistency of 3 percent. The thick stock was sent to a machine chests and diluted to a consistency of about 1 percent.

The machine chest furnish was diluted to approximately 0.1 percent consistency and delivered to a forming fabric using a single layer headbox. A Voith Fabrics 2164 forming fabric was used and which had a speed of approximately 62 fpm. The resulting web was then transferred to a transfer fabric traveling at 56 fpm using a vacuum shoe to assist the transfer. At a second vacuum shoe assisted transfer, the web was delivered onto a throughdrying fabric. The web was dried with a throughdryer operating at a temperature of 400° C. The resulting basesheet was produced with an oven-dry basis weight of approximately 45 gsm.

In Example 13, a 10 percent rush-transferred web was molded onto the surface of a flat TAD fabric (934). In Example 14, the same web was molded onto the surface of a three-dimensional TAD fabric (Jetson), which served as treatment #1 illustrated in FIG. 1A. In Example 15, the same web was molded onto a three-dimensional TAD fabric (labeled IMv1.0), which also served as treatment #1 illustrated in FIG. 1A. The molded webs were then throughdried in their molded form. Treatment #2 consisted of two-sided adhesive printing prior to flattening the molded sheet onto a creping drum by using a flat impression roll. The resulting creped towel products made with the topographic TAD fabric (Examples 14-15) contained buckled regions of alternating high and low basis weight consistent with the topographic pattern imparted by treatment #1. Control Example 13 went through the printing and creping process, but no buckles were formed as the basesheet from the tissue machine was flat. The finished basis weight for the towel Examples 13-15 was approximately 55 gsm. The resulting product was equilibrated for at least 4 hours in TAPPI standard conditions (73° F., 50% relative humidity) before tensile testing.

The physical testing results from these materials are summarized in Table 2 below.

TABLE 2
Towel Data

| | | | CD | CD | CD | |
|---|---|---|---|---|---|---|
| | Transfer | TAD | Tensile | Stretch | Slope | CD TEA |
| Example | Fabric | Fabric | g/3″ | % | g/3″ | g · cm/cm\hat{ }2 |
| 13 | 2164 | 934 | 1336.54 | 17.09 | 7.99 | 24.60 |
| (Control) | | | | | | |
| 14 | Jetson | Jetson | 1045.37 | 22.77 | 3.38 | 18.01 |
| 15 | Jetson | Ironman | 988.99 | 20.29 | 3.44 | 17.54 |

Note the greater CD stretch and lower CD slope for the Jetson and Ironman buckled towel sheets of this invention. The unbuckled towel had a greater CD TEA, which is primarily because its CD tensile strength was greater.

### Examples 16 and 17

(Facial Tissue).

The facial tissue sheets of Examples 16 and 17 were produced generally in accordance with the process illustrated in FIG. 3. More specifically, these facial examples were produced using a pilot throughdried creping tissue machine to produce a one-ply, creped throughdried facial tissue basesheet. More specifically, 50 pounds of bleached northern softwood kraft fiber were dispersed in a pulper for 30 minutes at a consistency of 3 percent. Similarly, 150 pounds of bleached eucalyptus were dispersed in a pulper for 30 minutes at a consistency of 3 percent. The thick stock of both fiber sources were sent separately to machine chests and diluted to a consistency of about 1 percent.

The machine chest furnish was diluted to approximately 0.1 percent consistency and delivered to a forming fabric using a three-layered headbox. The layer fiber weight split was 33 percent/34 percent/33 percent, with 100 percent eucalyptus fiber in the two outer layers and 100% softwood in the middle layer. The Voith Fabrics 2164 forming fabric speed was approximately 62 fpm. The resulting web was then transferred to a transfer fabric traveling at 56 fpm using a vacuum shoe to assist the transfer. At a second vacuum shoe assisted transfer, the web was delivered onto a throughdrying fabric. The web was partially dried with a throughdryer operating at a temperature of 175° C. The basesheet was produced with an oven-dry basis weight of approximately 15 gsm.

The primary differences between Examples 16 and 17 and the previous Examples 4-12′was that Treatment #1 in this case was conducted on the TAD fabric (as opposed to the transfer fabric for Examples 4-12) and Treatment #2 was conducted upon molding into the carrier fabric and to some extent in the impression nip during application of the web to the moving dryer.

As previously defined, the Asten 852 and Voith Fabrics 44GST are flat fabrics. The fabrics used in Example 17 were a three-dimensional TAD fabric (Jetson) and a flat impression fabric (852). Normally, the function of a three-dimensional TAD fabric in a process of this type is to pre-strain the sheet for improved molding into the impression fabric. However, when the impression fabric is extremely flat, as is the 852 fabric, very little molding can occur due to the lack of topography in the impression (or carrier) fabric. Consequently, the excess sheet path-length created by the pre-straining step is translated into buckled regions as depicted in FIG. 1. These buckled regions correspond to the walls of the ripple feature on the Jetson throughdrying fabric as depicted in FIG. 1A. The CD tensile data for two facial tissue sheets (unconverted basesheets) are presented in Table 3 below.

TABLE 3
Facial Tissue Data

| | | Im- | | CD | CD | |
|---|---|---|---|---|---|---|
| | Tad | pression | Caliper | Stretch | Slope | CDTEA |
| Example | Fabric | Fabric | um | % | g/3″ | g · cm/cm\hat{ }2 |
| 16 | 44GST | 852 | 510 | 8.8 | 12.9 | 6.9 |
| (Control) | | | | | | |
| 17 | Jetson | 852 | 524 | 14 | 7.8 | 9.2 |

As shown, compared to a sheet made with a relatively flat TAD fabric (44GST), the micro-buckled sheet of this invention has significantly more CD stretch while maintaining a fairly flat appearance. In this example, buckled regions were produced at web consistencies of 40 percent or greater due to the pre-drying effect of the through-dryer.

It will be appreciated that the foregoing examples, given for purposes of illustration, are not to be construed as limiting the scope of this invention, which is defined by the following claims and all equivalents thereto.

We claim:

1. A method of making a tissue or towel sheet comprising:
(a) forming a wet tissue web by depositing an aqueous suspension of papermaking fibers onto a forming fabric;
(b) transferring the wet tissue web to a molding fabric which imparts a three-dimensional contour to the web, said contour having spaced-apart elongated elevated regions aligned in the machine direction;
(c) removing the wet molded web from the molding fabric; and
(d) flattening the molded web, wherein elongated machine direction-oriented buckled regions are created, said buckled regions having a basis weight that is higher than the average basis weight of the web.

2. The method of claim 1 wherein the molding fabric is a transfer fabric and the web is flattened by subsequent transfer to a relatively flat throughdrying fabric and dried.

3. The method of claim 1 wherein the molding fabric is a throughdrying fabric, upon which the web is partially dried, and the resulting molded web is flattened by transfer to a relatively flat carrier fabric.

4. The method of claim 1 wherein the molding fabric is a throughdrying fabric, upon which the web is partially dried, and the resulting molded web is flattened in a nip between a creping cylinder and a pressure roll.

5. The method of claim 1 wherein the molding fabric is a throughdrying fabric, upon which the molded web is dried, wherein at least one surface of the dried molded web is provided with a bonding agent and the molded web is subsequently flattened in the hip between a creping cylinder and a pressure roll.

6. A tissue or towel sheet having a pattern of spaced-apart, elongated, substantially machine direction-oriented buckled regions having a basis weight greater than the average basis weight of the sheet.

7. The tissue or towel of claim 6 having a buckled tissue index of about −0.05 or less.

8. The tissue or towel of claim 6 having a buckled tissue index of from about −0.05 to about −0.4.

9. The tissue or towel of claim 6 having a buckled tissue index of from about −0.10 to about−0.35.

10. The tissue or towel sheet of claim 6 having a CD stretch of about 5 percent or greater.

11. The tissue or towel sheet of claim 6 having a CD stretch of from about 5 to about 25 percent.

12. The tissue or towel sheet of claim 6 having a CD stretch of from about 10 to about 20 percent.

13. The tissue or towel sheet of claim 6 having a CD TEA of about 3 grams-centimeter or greater per square centimeter.

14. The tissue or towel sheet of claim 6 having a CD TEA of from about 3 to about 30 grams-centimeter per square centimeter.

15. The tissue or towel sheet of claim 6 having a CD TEA of from about 5 to about 25 grams-centimeter per square centimeter.

16. The tissue or towel sheet of claim 6 wherein the ratio of the basis weight of the machine direction-oriented buckled regions relative to the average basis weight of the sheet is about 1.5 or greater.

17. The tissue or towel sheet of claim 6 wherein the ratio of the basis weight of the machine direction-oriented buckled regions relative to the average basis weight of the sheet is from about 1.5 to about 3.

18. The tissue or towel sheet of claim 6 wherein the ratio of the basis weight of the machine direction-oriented buckled regions relative to the average basis weight of the sheet is from about 2.0 to about 2.5.
